(19) United States
(12) Patent Application Publication
(10) Pub. No.: US 2005/0036049 A1
(43) Pub. Date: Feb. 17, 2005

(54) Image sensor IC

(76) Inventor: Satoshi Machida, Chiba-shi (JP)

Correspondence Address: ADAMS & WILKS, 50 Broadway, 31st Floor, New York, NY, 10004, US

(21) Appl. No.: 10/891,728

(22) Filed: Jul. 15, 2004

(30) Foreign Application Priority Data
Jul. 16, 2003 (JP) 2003-197973

(51) Int. Cl. H04N 5/335

(52) U.S. Cl. 348/308

(57) ABSTRACT

To provide an Image sensor for resolving a problem in that a transverse streak Is caused on a read image. The image sensor IC includes: a plurality of photoelectric conversion elements; a plurality of reset units for initializing the photoelectric conversion elements, which are respectively connected with the photoelectric conversion elements; a reference voltage circuit for generating a reset voltage supplied to the reset means; and a low pass filter provided between the reset units and the reference voltage circuit.

### BACKGROUND OF THE INVENTION

1. Field of the Invention

The present invention relates to a photoelectric conversion device that receives reflection light on an original irradiated with light and converts the received reflection light into an electrical signal. In particular, the present invention relates to a linear image sensor IC applied to an image reading apparatus such as a facsimile machine or an image scanner, and a contact type image sensor on which a plurality of image sensor ICs are mounted. In addition, the present invention relates to an area image sensor IC.

2. Description of the Related Art

FIG. 16 is a circuit diagram showing an image sensor IC used in a conventional image reading apparatus and FIG. 17 is a timing chart of the image sensor IC (for example, see JP 11-239245 A).

An N-type region of a photodiode 101 is connected with a positive power source voltage terminal VDD and a P-type region thereof is connected with a drain of a reset switch 102 and a gate of a source follower amplifier 103. A reference voltage VREF1 is provided to a source of the reset switch 102. A source of the source follower amplifier 103 serving as an output thereof is connected with a read switch 105 and a constant current source 104. A reference voltage VREFA as a constant voltage is provided to a gate of the constant current source 104. Elements within a photoelectric conversion block An shown in FIG. 16 are provided for each pixel. The read switch 105 of each photoelectric conversion block is connected with a common signal line 106. Note that the photoelectric conversion block An indicates a photoelectric conversion block of an nth-bit.

The common signal line 106 is connected with an inverting terminal of an operational amplifier 109 through a resistor 110. An output terminal of the operational amplifier 109 is connected with an output terminal 116 through a chip select switch 112 and a capacitor 113. The common signal line 106 is connected with a signal line reset switch 107. A reference voltage VREF2 is provided to a source of the signal line reset switch 107. A resistor 111 is connected between the output terminal and the inverting terminal of the operational amplifier 109. A non-inverting terminal of the operational amplifier 109 is fixed to be a constant voltage VREF3. The operational amplifier 109, the resistor 110, and the resistor 111 compose an inverting amplifier D.

An output terminal 116 of the image sensor IC is connected with a drain of a MOS transistor 114. A reference voltage VREF4 is provided to a source of the MOS transistor 114. The output terminal 116 of the Image sensor IC Is also connected with a capacitor 115 such as a parasite capacitor. A capacitor 113, the capacitor 115, and the MOS transistor 114 compose a clamp circuit C.

However, in such an image sensor IC, an optical signal is read after optical charge storage, and then the photo diode is reset. After that, a reference signal is read and subtracted from the optical signal. Therefore, there is a problem in that a reset level on the reference signal is different from that on the optical signal. That is, because the reset levels obtained at different timings are compared with each other, there is a problem in that a noise among reading lines is large.

The reset voltage VREF1 is generally supplied from a reference voltage circuit included in each image sensor IC. In particular, when a noise is on a power source voltage, the reset voltage also varies, so that the reset level of the photo diode fluctuates every resetting. Therefore, a signal level varies on each reading line, with the result that a transverse streak is caused on a read image.

In particular, when a low cost switching power source is used, the reset voltage significantly varies by a spike noise of the switching power source, so that a variation in signal level on each reading line becomes larger

### SUMMARY OF THE INVENTION

To solve the above problem, according to an aspect of the present invention, there is provided an image sensor IC, including: a plurality of photoelectric conversion elements; a plurality of reset means for initializing the photoelectric conversion elements, which are respectively connected with the photoelectric conversion elements; a reference voltage circuit for generating a reset voltage supplied to the reset means; and a low pass filter provided between the reset means and the reference voltage circuit.

Further, according to a further aspect, the low pass filter includes a resistor element having a resistance value of 1 kO or more and provided between an output terminal for the reference voltage and the reset means and a capacitor element having has a capacitance value of 10 pF or more and provided between the reset means and a constant voltage terminal.

Further, according to a further aspect, each of the reset means includes a switch element.

Further, according to a further aspect, there is provided an image sensor, including: a substrate; and a plurality of image sensor ICs according to any one of the above aspects, which are formed on the substrate and electrically connected with one another.

According to the image sensor IC, even when a spike noise is on a power source voltage and the reference voltage on the output terminal varies, a variation in reset voltage is suppressed by the low pass filter of a subsequent stage. Therefore, a constant reset voltage can be always supplied, so that the photoelectric conversion elements are always initialized to a constant initial voltage. Thus, it is possible to resolve a problem in that a signal level varies on each reading line, thereby causing a transverse streak on a read image.

When a simple structure is used for a contact type image sensor composed of a plurality of image sensor ICs, it is possible to resolve a problem in that a transverse streak is caused on a read image.

### BRIEF DESCRIPTION OF THE DRAWINGS

In the accompanying drawings:

FIG. 1 is a schematic diagram showing an image sensor IC according to a embodiment of the present invention;

FIG. 2 is a schematic diagram showing a photoelectric conversion device according to a first embodiment of the present invention;

FIG. 3 is an entire structural diagram showing the photoelectric conversion device according to the embodiment of the present invention;

FIG. 4 is a timing chart with respect to the photoelectric conversion device and a signal processing circuit according to the first embodiment of the present invention;

FIG. 5 is a schematic diagram showing a photoelectric conversion device according to a second embodiment of the present invention;

FIG. 6 is a timing chart with respect to a photoelectric conversion device and a signal processing circuit according to the second embodiment of the present invention;

FIG. 7 is a block diagram showing the signal processing circuit according to the embodiment of the present invention;

FIG. 8 Is a circuit diagram showing a sample-and-hold circuit according to the embodiment of the present invention;

FIG. 9 is a circuit diagram showing a buffer circuit according to the embodiment of the present invention;

FIG. 10 is a circuit diagram showing an amplifying circuit according to the embodiment of the present invention;

FIG. 11 is a circuit diagram showing a subtractor according to the embodiment of the present invention;

FIG. 12 is a circuit diagram showing a clamp circuit according to the embodiment of the present invention;

FIG. 13 is a circuit diagram showing a reference voltage circuit and a low pass filter according to the embodiment of the present invention;

FIG. 14 is a circuit diagram showing a reference voltage circuit and a low pass filter according to the embodiment of the present invention;

FIG. 15 is a schematic diagram showing a contact type image sensor according to the embodiment of the present invention;

FIG. 16 is a circuit diagram showing a conventional image sensor IC; and

FIG. 17 is a timing chart of the conventional image sensor IC.

### DETAILED DESCRIPTION OF THE PREFERRED EMBODIMENTS

Hereinafter, the present invention will be described with reference to the drawings.

<First Embodiment>

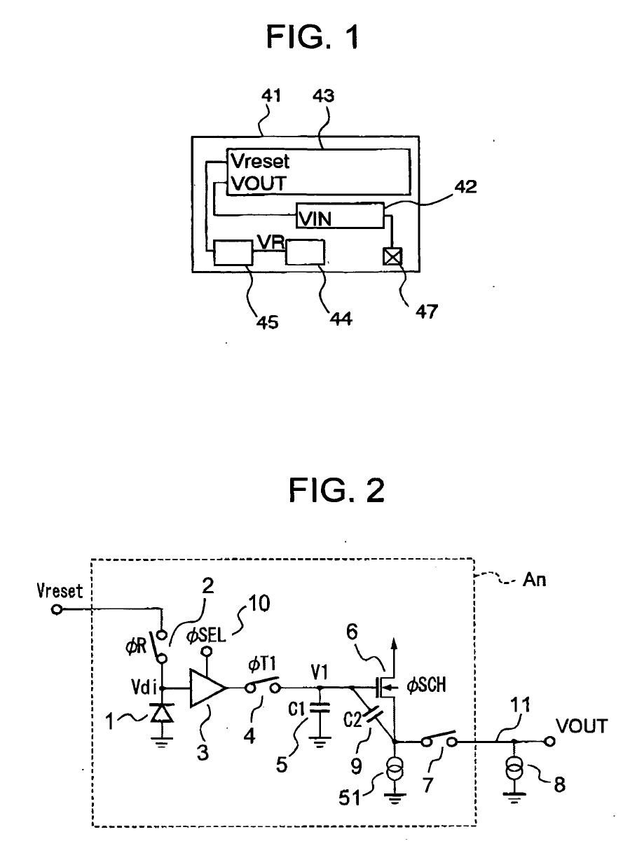

FIG. 1 is a schematic diagram showing an image sensor IC according to a embodiment of the present invention. An image sensor IC 41 includes a signal processing circuit 42, a photoelectric conversion device 43, a reference voltage circuit 44, a low pass filter 45, and a signal output terminal 47. A common signal line of the photoelectric conversion device 43 is connected with the signal processing circuit 42. An output of the signal processing circuit 42 is connected with the signal output terminal 47.

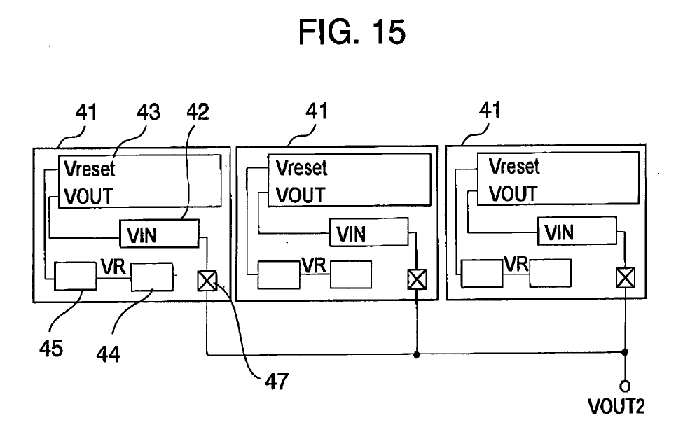

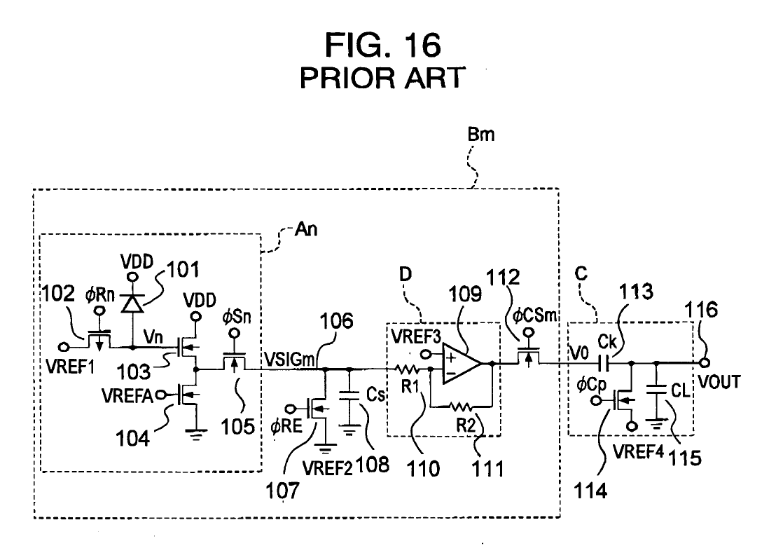

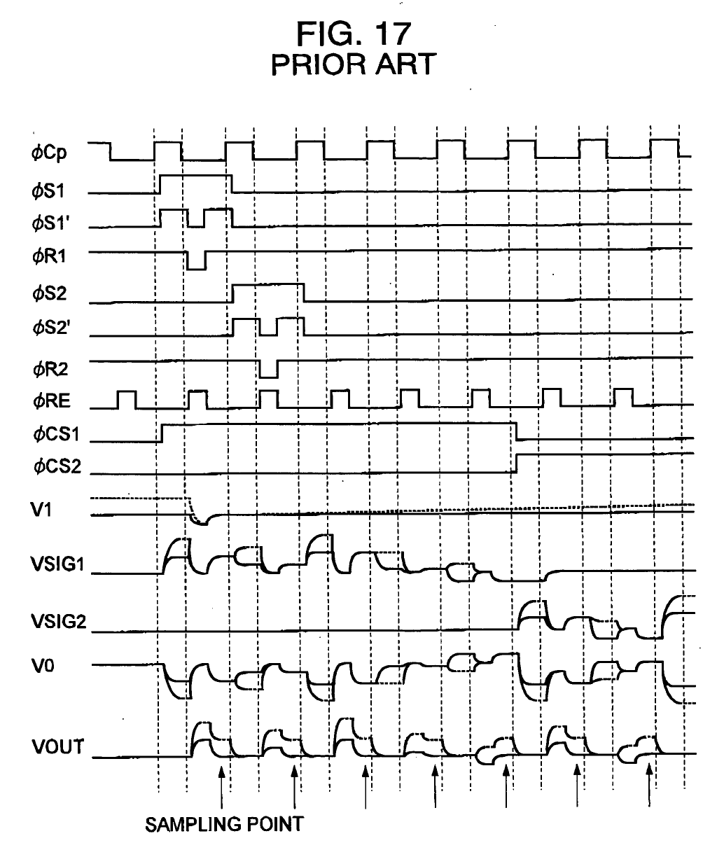

FIG. 15 is a schematic diagram showing a contact type image sensor using the image sensor IC 41 shown in FIG. 1. The contact type image sensor is composed of three image sensor ICs 41. The signal output terminals 47 of the image sensor ICs 41 are connected with one another at the outside. The outputs of the image sensor ICs 41 are outputted from a VOUT2 terminal to the outside.

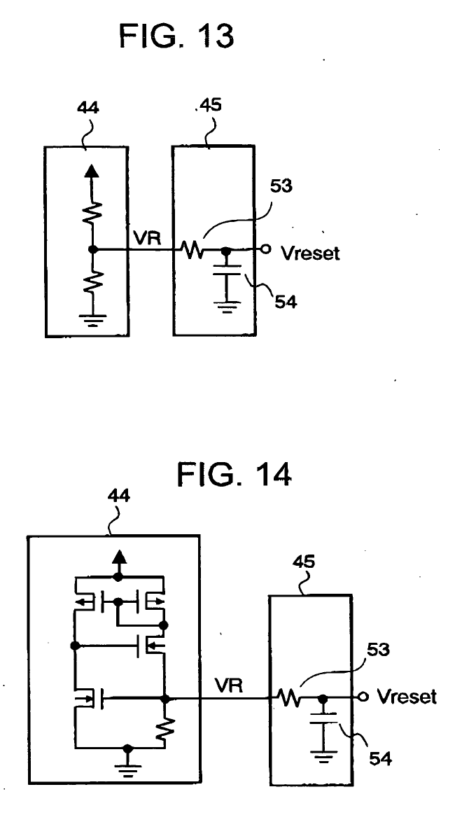

FIGS. 13 and 14 are circuit diagrams showing examples of the reference voltage circuit 44 and the low pass filter 45 in the image sensor IC 41. In FIG. 13, a reference voltage is produced by dividing a power source voltage VDD by resistors. Therefore, when the power source voltage varies, an output voltage VR of the reference voltage varies by a resistance division value of a variation in power source voltage.

With respect to the reference voltage in FIG. 14, a variation in. the output voltage VR is smaller than a variation in power source voltage. However, the variation in the output voltage VR cannot be reduced to 0.

In any circuit, a high frequency component of a variation in VR is cut by the low pass filter 45 of a subsequent stage, so that a variation in Vreset is suppressed. In particular, when the variation In power source voltage is a spike noise, the variation is substantially the high frequency component, so that the variation in vreset becomes smaller. The lowpass filter 45 includes a resistor element 53 and a capacitor element 54. A cutoff frequency of the low pass filter is determined in consideration of a noise frequency distribution of the power source voltage. In an experiment using a switching power source, when a resistance value is 1 kO or more and a capacitance value is 10 pF or more, an effect is obtained. Note that one terminal of the capacitor element may be connected with a terminal other than a GND terminal if the terminal Is kept to be a constant voltage.

A structure of the low pass filter is not limited to the above-mentioned structures.

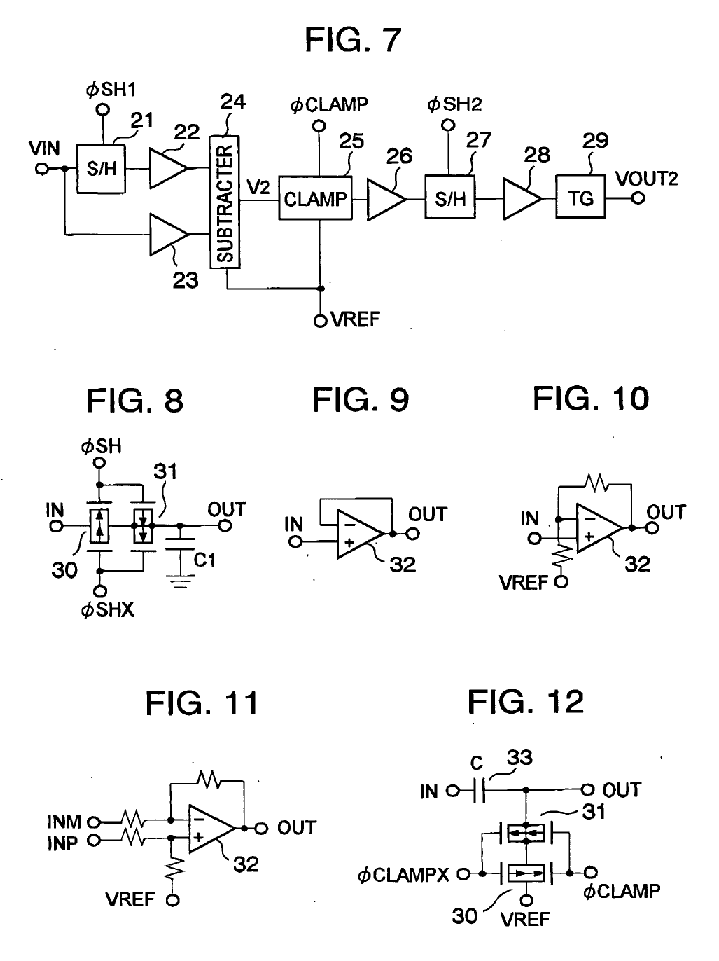

FIG. 7 is a block diagram showing the signal processing circuit 42 according to this embodiment of the present invention. A signal which is inputted to an input terminal VIN is inputted to a sample-and-hold circuit 21 and a buffer amplifier 23. An output of the sample-and-hold circuit 21 is inputted to a buffer amplifier 22. An output of the buffer amplifier 22 and an output of the buffer amplifier 23 are inputted to a subtractor 24. An output of the subtractor 24 is inputted to a clamp circuit 25. The subtractor 24 and the clamp circuit 25 can have a common reference voltage and are connected with a VREF terminal. An output of the clamp circuit 25 is inputted to a buffer circuit 26. Note that the buffer circuit 26 may be replaced by an amplifying circuit. The amplifying circuit may be connected with the VREF terminal to use the common reference voltage. An output of the buffer circuit 26 is inputted to a sample-and-hold circuit 27. An output of the sample-and-hold circuit 27 is inputted to a buffer amplifier 28. An output of the buffer amplifier 28 is inputted to a transmission gate 29. An output of the transmission gate 29 is connected with an output terminal VOUT2. Note that the transmission gate 29 can be omitted according to usage.

FIG. 8 is a circuit diagram showing the sample-and-hold circuit according to this embodiment of the present invention, which can be used for the sample-and-hold circuit 21 and the sample-and-hold circuit 27. The sample-and-hold circuit includes a transmission gate 30, a dummy switch 31, and a capacitor C1. In the sample-and-hold circuit, in order to offset a noise of a pulse fSH against a noise of an inverting pulse fSHX, NMOS and PMOS transistors composing the transmission gate 30 are set to the same size. In addition, a gate area of NMOS and PMOS transistors composing the dummy switch 31 is set to a half of a gate area of the transistors composing the transmission gate.

FIG. 9 is a circuit diagram showing the buffer amplifier according to this embodiment of the present invention, which is an operational amplifier 32. This circuit can be used for the buffer amplifiers 22, 23, 26, and 28. Note that the buffer amplifier may be a source follower amplifier.

FIG. 10 is a circuit diagram showing the amplifying circuit according to this embodiment of the present invention, which includes an operational amplifier 32 and resistors. When this circuit is used instead of the buffer amplifier 26, a gain of the signal processing circuit can be increased. The amplifying circuit may be connected with the VREF terminal shown in FIG. 1 to use a common reference voltage VREF.

FIG. 11 is a circuit diagram showing the subtractor according to this embodiment of the present invention, which includes an operational amplifier 32 and resistors. In this circuit, a voltage obtained by subtracting a voltage on an INM terminal from a voltage on an INP terminal is multiplied by a gain determined from a resistance ratio and outputted using a voltage on the reference terminal VREF as a reference. When the INP terminal and the INM terminal are inversely connected with the operational amplifier 32, the output can be inverted based on the voltage of the VREF terminal as a reference.

FIG. 12 is a circuit diagram showing the clamp circuit according to this embodiment of the present invention, which can be used for the clamp circuit 25. The claim circuit includes a transmission gate 30, a dummy switch 31, and a capacitor 33. In the clamp circuit, In order to offset a noise of a pulse fCLAMP against a noise of an inverting pulse fCLAMPX, NMOS and PMOS transistors composing the transmission gate 30 are set to the same size. In addition, a gate area of NMOS and PMOS transistors composing the dummy switch 31 is set to a half of a gate area of the transistors composing the transmission gate.

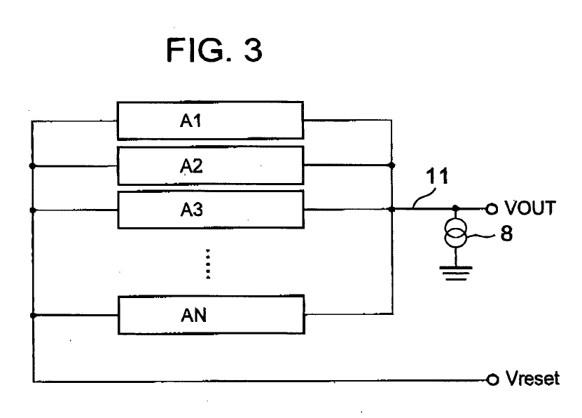

As shown in FIG. 3, the photoelectric conversion device 43 shown in FIG. 1 is composed of a plurality of photoelectric conversion blocks A1, A2, . . . , An. FIG. 2 shows an example of one of the photoelectric conversion blocks A1, A2, . . . , An and is a schematic circuit diagram showing the photoelectric conversion device according to this embodiment of the present invention. Elements included in the photoelectric conversion block An shown in FIG. 2 are provided for each pixel. A channel selection switch 7 of each of the blocks is connected with a common signal line 11. Note that the photoelectric conversion block An indicates a photoelectric conversion block of an nth-bit. This block includes a photo diode 1 serving as a photoelectric conversion section, a transfer switch 4 serving as a change transfer section, a reset switch 2 serving as a reset section, an amplifier section 3, a capacitor 5, a MOS transistor 6 composing a MOS source follower, the channel selection switch 7 serving as a channel selection section, the common signal line 11, and a first current source 8.

One terminal of the reset switch 2 is connected with a Vreset terminal. The Vreset terminals of all the photoelectric conversion devices are commonly connected with one another as shown in FIG. 3.

The amplifier section 3 may be constructed by a MOS source follower, a voltage follower amplifier, or the like, and an amplifier-enable terminal 10 for selecting an operational state thereof may be provided therein. A parasitic capacitor 9 is present between a gate of the MOS transistor 6 and a source thereof. The source of the MOS transistor 6 is connected with a second current source 51. The current source 51 is turned on/off in response to an enable signal fRR. In an on-state, the same level of current as the first current source 8 flows.

An output terminal VOUT of the photoelectric conversion block is connected with the input terminal VIN of the signal processing circuit shown in FIG. 7. The photoelectric conversion device and the signal processing circuit can be formed on a single semiconductor substrate.

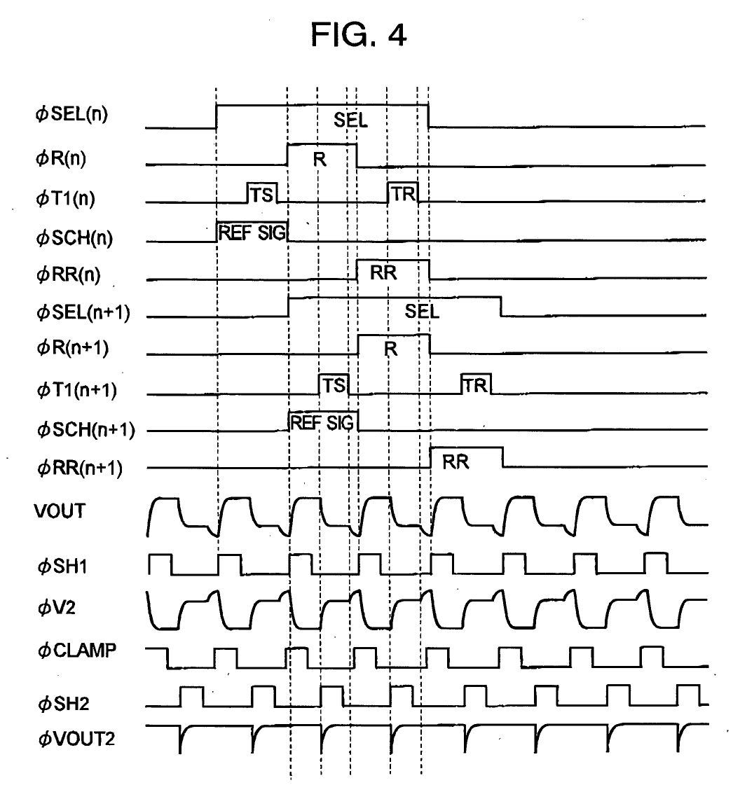

FIG. 4 is a timing chart with respect to the photoelectric conversion device and the signal processing circuit according to this embodiment of the present invention.

Hereinafter, an operation in this embodiment will be described with reference to the timing chart.

First, an operation of a photoelectric conversion block of an nth-bit will be described.

When the reset switch 2 is turned on in response to Fr(n). an output terminal VDU of the photo diode 1 is fixed to be a reference voltage Vreset. When the reset switch 2 is turned off, a voltage on the output terminal VDU becomes a value obtained by adding an off noise to the reference voltage Vreset.

As described above, even when a spike noise is on the power source voltage and an output voltage VR of the reference voltage varies, a variation in reset voltage Vreset is suppressed by the low pass filter 45 of a subsequent stage. Therefore, the voltage on the output terminal VDU does not vary every resetting, so that it is kept constant.

After the reset switch 2 is turned off in response to fr(n), the transfer switch 4 is turned on in response to fT1(n) and the reference signal is read into the capacitor 5 during a period TR. At this time, the current source 51 is turned on In response to the enable signal fRR(n), so that a source potential of the MOS transistor 6 is set to the same level as in reading that fSCH(n) is in an on-state. The reference signal is hold in the capacitor 5 for one period. For this period, an optical charge is stored in the photo diode 1 and a potential at the output terminal Vdi varies according to the amount of optical charge. When the channel selection switch 7 is turned on in response to fSCH(n) during a next period, the reference signal held in the capacitor 5 is read to the common signal line 11 during a period REF. Next, when fT1(n) is set to an on-state to read an optical signal into the capacitor 5, the optical signal is read to the common signal line 11. At this time, the current source 51 is turned off. Therefore, the source potential of the MOS transistor 6 at a time when the reference signal is read into the capacitor 5 during the period TR can be set to the same level as at a time when the optical signal to corresponding the charge stored in the photo diode during a period TS is read into the capacitor 5. Thus, the influence of the parasitic capacitor 9 on the charge stored in the capacitor 5 can be suppressed, so that an offset of a dark output voltage can be reduced.

According to the above-mentioned operation, when output voltages VOUT from the common signal line 11 during the period REF and a period SIG of fSCH(n) are subtracted from each other, a fixed pattern noise and a random noise caused by the reset switch 2 can be removed. Next, after fT1(n) is set to an off-state, fSCH(n) is set to an off-state and fR(n) is set to an on-state to reset the photo diode 1 for next operation. Then, fT1(n) is set to an on-state again to read the reference signal into the capacitor 5 during the period TR.

After fSCH(n) is set to an off-state, the channel selection switch 7 for a next bit is turned on in response to fSCH(n+1) to start reading of a reference signal for the next bit. All other pulses for (n+1)-th bit are delayed by a non-period of fSCH as compared with the pulses for the nth bit.

In the above description, the second current source 51 may be omitted. In this case, the pulse fRR is unnecessary.

As described above, the reference signal for the nth bit, the optical signal for the nth bit, the reference signal for the (n+1)-th bit, and the optical signal for the (n+1)-th bit are outputted in order from the output terminal VOUT. Hereinafter, for the sake of convenience, assume that an output period of the reference signal is a first half period and an output period of the optical signal is a second half period.

Next, an operation of the signal processing circuit will be described.

An output from the output terminal VOUT is inputted to a VIN terminal. A sample-and-hold pulse fSH1 is set to an on-state after the start of the reference signal and set to an off-state before the end of the reference signal. Therefore, the reference signal is sampled and held. The signal at the VIN terminal and the signal which is sampled and held are inputted to the subtractor. the same reference signal is inputted to the subtractor during the first half period. The reference signal and the optical signal which are sampled and held are inputted to the subtractor during the second half period. An output of the subtractor during the first half period becomes a VREF level. The output during the second half period becomes a level obtained by adding the VREF level to a level obtained by multiplying a difference between the reference signal and the optical signal by a gain. Offsets of the buffer amplifiers 22 and 23 and the subtractor 24 are superposed on the output during the first half period. The offsets of the buffer amplifiers 22 and 23 and the subtractor 24 and an offset of the sample-and-hold circuit 21 are superposed on the output during the second half period.

The clamp pulse fCLAMP is set to an on-state before fSH1 becomes an on-state and set to an off-state before fSH1 becomes an off-state. Therefore, the output of the clamp circuit 25 is clamped to be the VREL level during the first half period. During the second half period, the output becomes a level obtained by adding the VREF level to a level obtained by subtracting a first half output of the subtractor from a second half output thereof. As a result, the offsets of the buffer amplifiers 22 and 23 and the subtractor 24 are not superposed on the output of the clamp circuit during the second half period. In addition, the offset of the sample-and-hold circuit 21 is small because it is a circuit for offsetting a noise of the pulse fSH against a noise of the inverting pulse fSHX. Thus, the output of the clamp circuit during the second half period becomes the level obtained by adding the VREF level serving as a reference to the level obtained by multiplying the difference between the reference signal and the optical signal by the gain.

A sample-and-hold pulse fSH2 is set to an on-state before or after the start of the optical signal and set to an off-state before the end of the optical signal. Therefore, the clamped output during the second half period is sampled and then held during the first half period for a next bit. Thus, an output level can be maintained for a long period.

<Second Embodiment>

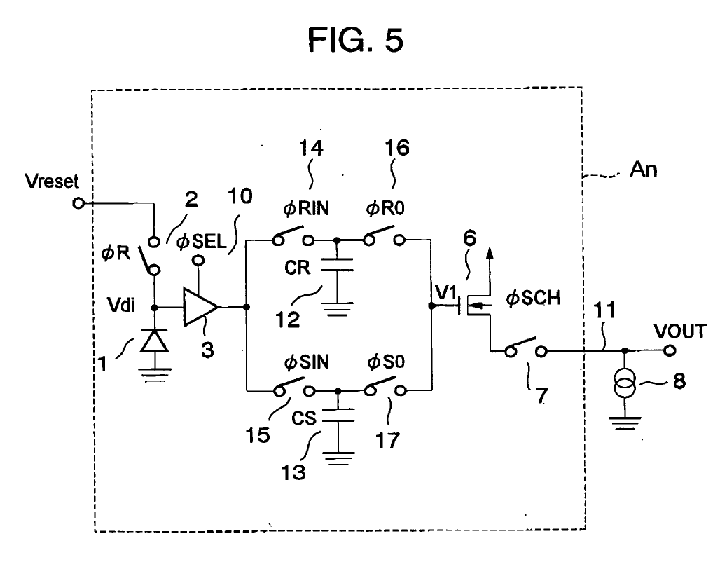

FIG. 5 Is a schematic circuit diagram showing the photoelectric conversion device according to a second embodiment of the present invention. Elements included in the photo electric conversion block An shown in FIG. 5 are provided for each pixel. The channel selection switch 7 of each of the blocks is connected with the common signal line 11. Note that the photoelectric conversion block An indicates a photoelectric conversion block of an nth-bit. FIG. 3 is an entire structural diagram showing the photoelectric conversion device 43.

This block includes the photo diode 1 serving as the photoelectric conversion section, transfer switches 14, 15, 16, and 17 serving as change transfer sections, the reset switch 2 serving as the reset section, the amplifier section 3, a capacitor 13 for holding an optical signal, a capacitor 12 for holding a reference signal serving as a reference in the photoelectric conversion section, the MOS transistor 6 composing the MOS source follower, serving as a signal reading section, the channel selection switch 7 serving as the channel selection section, the common signal line 11, and the first current source 8.

One terminal of the reset switch 2 is connected with the Vreset terminal. The Vreset terminals of all the photoelectric conversion devices are commonly connected with one another as shown in FIG. 3.

The amplifier section 3 may be constructed by the MOS source follower, the voltage follower amplifier, or the like, and the ampllfier-enable terminal 10 for selecting an operational state thereof may be provided therein.

The output terminal VOUT of the photoelectric conversion block is connected with the input terminal VIN of the signal processing circuit shown in FIG. 7. The photoelectric conversion device and the signal processing circuit can be formed on a single semiconductor substrate.

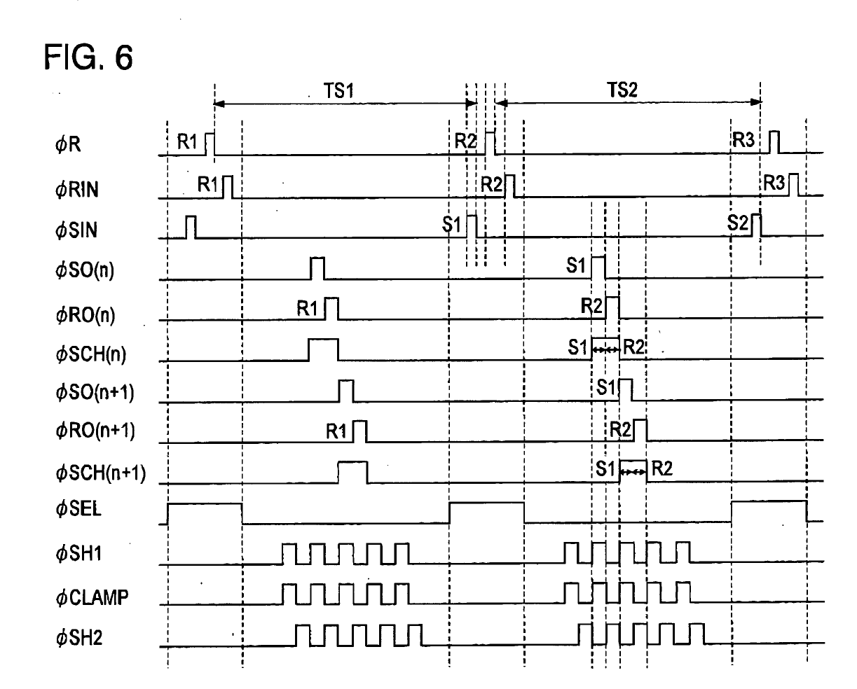

FIG. 6 is a timing chart with respect to the photoelectric conversion device and the signal processing circuit according to this embodiment of the present invention.

Hereinafter, an operation of the photoelectric conversion device will be described with reference to the timing chart.

In FIG. 6, fR, fRIN, fSIN, and fSEL are simultaneously used for all bits. Because use timings of fSO, fRO, and fSCH are changed according to a bit, they are indicated with (n).

First, an operation of a photoelectric conversion block of an nth-bit will be described.

The transfer switch 15 is turned on in response to the pulse fSIN at a position S1, so that an optical signal obtained after the storage of charges produced by light incident on the photo diode 1 is read into the capacitor 13. Next, when the reset switch 2 is turned on in response to the pulse fR at a position R2, the output terminal Vdi of the photo diode 1 is fixed to be the reference voltage Vreset. When the reset switch 2 is turned off, a voltage on the output terminal Vdi becomes a value obtained by adding an off noise to the reference voltage Vreset.

As described above, even when a spike noise is on the power source voltage and the output voltage VR of the reference voltage varies, a variation in reset voltage Vreset is suppressed by the low pass filter 45 of a subsequent stage. Therefore, the voltage on the output terminal Vdi does not vary every resetting, so that it is kept constant.

Immediately after the reset switch 2 is turned off, the transfer switch 14 is turned on in response to fRIN at a position R2 to read a reference signal after the reset of the photo diode 1 into the capacitor 12. After that, an optical charge is stored in the photo diode 1. A potential at the output terminal Vdi varies according to the amount of optical charge. The storage period is from the end of the pulse fR at R2 to the end of the pulse fSIN at S2 during a next period, so that it becomes a period TS2 shown in FIG. 6. Therefore, the storage periods for all bits are equal to one another.

Next, a read operation with respect to the reference signal and the optical signal will be described.

During the storage period TS2 shown in FIG. 6, when the channel selection switch 7 is opened in response to the pulse fSCH(n) and simultaneously the transfer switch 17 Is opened in response to the pulse fSO(n), the optical signal held in the capacitor 3 is read to the common signal line 11. This period corresponds to S1 of fSCH(n).

The optical signal is a signal stored during a period TS1, which is based on a reset voltage reset by the pulse fR at the position R1.

Next, when the transfer switch 16 is opened in response to the pulse fRO(n), the reference signal held in the capacitor 12 is read to the common signal line 11. The reference signal is a signal reset by the pulse fR at the position R2.

When a difference between the optical signal and the reference signal is obtained by the signal processing circuit of a subsequent stage, a difference of reset revels at different pulses fR is obtained. However, a thermal noise of the reference voltage Vreset is small, so that only a voltage difference caused by light can be obtained.

Next, after fSCH(n) is set to an off-state, the channel selection switch 7 for a next bit is turned on in response to fSCH(n+1). Then, when the transfer switch 17 for the next bit is opened in response to the pulse fSO(n+1), reading of an optical signal for the next bit starts. All other pulses for (n+1)-th bit are delayed by the on-period of fSCH as compared with the pulses for the nth bit.

In this embodiment, during the storage operation of the photo diode for the period TS2, the optical signal stored during the preceding storage period TS1 can be read. Therefore, LEDs of three colors of R, G, and B can be turned on in succession to read color image data. For example, during the period TS1, the red LED is turned on to read a red component. During the period TS2, the green LED is turned on to read a green component. During a period next to the period TS1, the blue LED is turned on to read a blue component. In such a case, a red optical signal is read during the period TS2.

As described above, the optical signal for the nth bit, the reference signal for the nth bit, the optical signal for the (n+1)-th bit, and the reference signal for the (n+1)-th bit are outputted in order from the output terminal VOUT on the common signal line 11. This order is reverse to the output order of optical signal and the reference signal in the photoelectric conversion device according to the first embodiment. However, when the pulses fSH1, fCLAMP, and fSH2 as shown in FIG. 6 are used, the difference between the optical signal and the reference signal can be amplified using the reference voltage VREF as a reference by the signal processing circuit shown in FIG. 7 as in the photoelectric conversion device according to the first embodiment.

In the above description, the photoelectric conversion device may be any circuit for outputting the reference signal and the optical signal in order. Signal processing can be performed for a linear sensor and an area sensor. Even when the output order of optical signal and the reference signal is reverse, the INP terminal and the INM terminal of the subtractor are reversely connected, processing is possible. When the INP terminal and the IN terminal of the subtractor are reversely connected, the output of the subtractor is inverted based on the VREF level. Therefore, even when the sensitivity of the optical signal Is positive or negative, the sensitivity of the signal processing circuit can be set to be positive.

In the above description of the image sensor IC of the present invention, it is possible not to include the signal processing circuit 42 in the IC.

The linear image sensor IC is mainly described. The structure shown in FIG. 1 can be applied to an area image sensor IC.

The present invention is not limited to the above-mentioned respective embodiments and can be embodied using various modifications without departing from a spirit of the present invention.

The present Invention can be used for a linear image sensor IC applied to an image reading apparatus such as a facsimile machine or an image scanner, and a contact type image sensor on which a plurality of image sensor ICs are mounted. In addition, the present invention can be applied to an area image sensor IC.

1. An image sensor IC, comprising:
a plurality of photoelectric conversion elements;
a plurality of reset means for initializing the photoelectric conversion elements, which are respectively connected with the photoelectric conversion elements;
a reference voltage circuit for generating a reset voltage supplied to the reset means; and
a low pass filter provided between the reset means and the reference voltage circuit.

2. An image sensor IC according to claim 1, wherein the low pass filter comprises a resistor element provided between an output terminal for the reference voltage and the reset means and a capacitor element provided between the reset means and a constant voltage terminal.

3. An Image sensor IC according to claim 2, wherein the resistor element has a resistance value of 1 kO or more and the capacitor element has a capacitance value of 10 pF or more.

4. An image sensor IC according to claim 1, wherein each of the reset means comprises a switch element.

5. An image sensor, comprising:
a substrate; and
a plurality of image sensor ICs according to claim 4, which are formed on the substrate and electrically connected with one another.

6. An image sensor, comprising:
a plurality of image sensor ICs according to claim 2, which are formed on the substrate and electrically connected with one another.
